(19) United States
(12) Patent Application Publication
(10) Pub. No.: US 2016/0337569 A1
(43) Pub. Date: Nov. 17, 2016

(54) METHOD AND APPARATUS FOR STROBED ILLUMINATION IN EYE BASED BIOMETRIC SYSTEMS

(71) Applicants: Salil PRABHAKAR, Fremont, CA (US); DELTA ID INC., Fremont, CA (US)

(72) Inventor: SALIL PRABHAKAR, Fremont, CA (US)

(21) Appl. No.: 15/112,348

(22) PCT Filed: Jan. 14, 2015
(86) PCT No.: PCT/US15/11329

§ 371 Date: Jul. 18, 2016

Related U.S. Application Data
(60) Provisional application No. 61/928,751, filed on Jan. 17, 2014.

(51) Int. Cl. H04N 5/235; G06K 9/00; H05B 37/02; H04N 9/07; G06K 9/20; H04N 5/225; H04N 5/33

(52) U.S. Cl. CPC H04N 5/2354; H04N 5/2256; G06K 9/00604; H04N 5/332; H04N 9/07; G06K 9/2027; H05B 37/0281

(57) ABSTRACT

The invention provides an apparatus, method and computer program product for eye based biometric recognition. The invention comprises (i) emitting a first set of radiation wavelengths from a first illumination source in a first strobing pattern, wherein the first set of radiation wavelengths fall within near infrared (NIR) spectrum and (ii) emitting a second set of radiation wavelengths from a second illumination source. At least part of the second set of radiation wavelengths fall within the visible spectrum and at least part of the second set of radiation wavelengths are distinct from the first set of radiation wavelengths. Additionally, one or more of timing, duration and intensity of illumination emitted by the second illumination source are modulated such that combined radiation emitted by the first illumination source and the second illumination source are perceived by a subject's eye as a continuous signal having a substantially constant intensity and color.

### FIELD OF THE INVENTION

The invention relates to a method and apparatus for providing strobed infrared (IR) or near-infrared (NIR) illumination in biometric systems that rely on distinctive characteristics of the eye (such as iris based biometrics or retina based biometrics).

### BACKGROUND

Eye based biometric devices typically require a subject's eye to be positioned in a prescribed region (i.e. within a desired eye capture volume corresponding substantially to an object plane of an imaging apparatus such as a camera), whereafter the eye is illuminated by an illumination source (such as LED(s), incandescent light(s), laser diode arrays) or other light source), and an image of the subject's eye is acquired for further processing. The illumination source requires to be powered by a power source, such as a battery or other energy source.

It has been established that eye based biometric apparatuses perform better when images of the eye (particularly for iris based systems) are acquired in the infrared (IR) region of the electromagnetic spectrum, and more particularly in the IR-A or near infrared region (NIR) of the electromagnetic spectrum i.e. when eye images are acquired using wavelengths falling between 700 nanometres (nm) and 1400 nm. Illumination sources presently used in eye based biometric apparatuses therefore include sources capable of illuminating the subject's eye with wavelengths falling within the IR or NIR spectrum.

It is however known that beyond certain pre-defined limits, exposure to IR and NIR spectrum wavelengths may cause retinal burns and cataractogenesis in eye tissue. This is a particular concern in biometric apparatuses which rely on simultaneous image capture and processing, wherein an illumination source continually illuminates the subject's eye while the camera acquires multiple images of the eye until either (a) the apparatus reaches a match or non-match decision or (ii) a predefined termination event (such as a timeout) occurs. Continuous illumination of the eye during image capture and processing increases exposure to IR and NIR spectrum wavelengths, with a corresponding increase in the attendant risks.

A known solution to the above problem is to pulse or flash the IR or NIR illumination source(s) in a predefined pattern (for example, synchronized to exposure time of an image sensor). This may be achieved using a strobing device or an illumination controller configured to strobe an illumination source, for the duration of image capture by an imaging apparatus or image sensor. It is also known to control intensity and duration of the strobed pulses to achieve appropriate image exposure. Strobing IR or NIR illumination reduces harmful radiation exposure of a subject's eye.

Strobed illumination however has its own drawbacks—in that it is known to cause physical discomfort, nausea, muscle tension, temporary loss of vision and epileptic seizures in subjects, and particularly in photosensitive individuals. Additionally, despite the fact that biometric devices rely on IR and NIR wavelengths for illuminating the eye (which wavelengths are understood to fall outside the visible spectrum), it has been found that the human eye is nevertheless sensitive to certain wavelengths within the NW spectrum. As a consequence, wavelengths emitted by IR and NIR illumination sources used for illumination in eye based biometric apparatuses (e.g. LED(s), LED arrays or other light sources) are perceivable by the unaided human eye—and are perceived as a (usually deep and/or dim) red glow emitted by the illumination source(s). An individual subjected to strobed illumination from an IR or NIR illumination source for the purposes of eye based biometric image capture would therefore see a pulsing red glow emitted from the illumination source—which pulsing glow corresponds to NIR wavelengths emitted by the illumination source and which may be sufficient to trigger a reaction in a photosensitive subject.

There is accordingly a need to harness benefits of strobing (i.e. reducing a subject's exposure to IR or NIR radiation) while avoiding the corresponding harms.

### SUMMARY

The invention provides an apparatus for eye based biometric recognition. The apparatus may comprise an imaging apparatus, a first illumination source configured to emit a first set of radiation wavelengths, wherein the first set of radiation wavelengths fall within near infrared (NW) spectrum, a second illumination source configured to emit a second set of radiation wavelengths, wherein at least part of the second set of radiation wavelengths fall within the visible spectrum and at least part of the second set of radiation wavelengths are distinct from the first set of radiation wavelengths. The apparatus may further comprise an illumination controller configured to strobe the first illumination source in a first strobing pattern and control one or more of timing, duration and intensity of illumination emitted by the second illumination source such that combined radiation emitted by the first illumination source and the second illumination source are perceived by a subject's eye as a continuous signal having a substantially constant intensity and color.

In an embodiment of the invention, the visible color characteristics of the second set of wavelengths may be substantially identical to visible color characteristics of the first set of wavelengths.

In another embodiment of the invention, the illumination controller may be configured to strobe the second illumination source in a second strobing pattern, wherein each pulse of one of the first strobing pattern and the second strobing pattern is substantially synchronized with each interval of the other of the first strobing pattern and the second strobing pattern.

In a particular embodiment, the first set of wavelengths may comprise wavelengths between 700 nm and 1400 nm, and the second set of wavelengths may comprise wavelengths between 600 nm and 750 nm.

The first set of wavelengths may consist essentially of wavelengths between 700 nm to 950 nm.

In another embodiment, the second set of wavelengths may consist essentially of wavelengths that are 660 nm.

In an embodiment of the invention, the illumination controller may be configured to control radiometric intensity and timing characteristics of pulses emitted by the first illumination source and radiometric intensity and timing characteristics of pulses emitted by the second illumination source such that instant or average radiometric intensity of pulses emitted by the first illumination source is higher than instant or average radiometric intensity of pulses emitted by the second illumination source.

In another embodiment, the illumination controller may be configured to control radiometric intensity and timing characteristics of pulses emitted by the first illumination source and radiometric intensity and timing characteristics of pulses emitted by the second illumination source such that instant or average visible intensity of pulses emitted by the first illumination source is substantially identical to instant or average visible intensity of pulses emitted by the second illumination source.

The first illumination source and the second illumination source may in a particular implementation be positioned such that their respective locations are substantially indistinguishable from within a field of view of the imaging apparatus.

In a specific embodiment, the apparatus may comprise a beam splitter configured to direct illumination from the first illumination source and from the second illumination source along a common light path onto an image capture region corresponding to the imaging apparatus.

The characteristics of the first strobing pattern and second strobing pattern may be selected such that said first and second strobing patterns are visible as a continuous signal of visible radiation having a substantially constant intensity and color.

In another embodiment of the invention, the visual strobing pattern resulting from a combination of the first strobing pattern and the second strobing pattern may effectively be modulated at a frequency ν such that ν≧55 Hz.

An embodiment of the apparatus may be configured wherein for a duration of a sequence of strobed illumination generated by the first illumination source, the second illumination source emits visible radiation, wherein visible intensity of radiation emitted by the second illumination source is higher than visible intensity of radiation emitted by the first illumination source, and the difference between each of the two visible intensities is sufficient to minimize changes in a subject's visual perception corresponding to strobing of the first illumination source.

In another embodiment, the emission spectrum of the second illumination source may be selected such that it has higher luminous efficacy than luminous efficacy of an illumination source configured to emit visible radiation having an emission spectrum color characteristic substantially identical to emission spectrum color characteristic of the first illumination source.

The second illumination source may be configured to have an emission color characteristic different from the emission color characteristic of the first illumination source.

In a specific embodiment, the second illumination source may emit a continuous signal of visible radiation.

The invention also provides a method for illuminating an image capture region of an eye based biometric recognition apparatus. The method may comprise emitting a first set of radiation wavelengths from a first illumination source in a first strobing pattern, wherein the first set of radiation wavelengths fall within near infrared (NIR) spectrum. The method may emit a second set of radiation wavelengths from a second illumination source, wherein at least part of the second set of radiation wavelengths fall within the visible spectrum and at least part of the second set of radiation wavelengths are distinct from the first set of radiation wavelengths wherein one or more of timing, duration and intensity of illumination emitted by the second illumination source are modulated such that combined radiation emitted by the first illumination source and the second illumination source are perceived by a subject's eye as a continuous signal having a substantially constant intensity and color.

In an embodiment of the above method, the visible color characteristics may be substantially identical to visible color characteristics of the first set of wavelengths.

In another embodiment, the second illumination source may be strobed in a second strobing pattern, such that each pulse of one of the first strobing pattern and the second strobing pattern is substantially synchronized with each interval of the other of the first strobing pattern and the second strobing pattern.

The first set of wavelengths may comprise wavelengths between 700 nm and 1400 nm, and the second set of wavelengths may comprise wavelengths between 600 nm and 750 nm.

In another embodiment, the first set of wavelengths may consist essentially of wavelengths between 700 nm to 950 nm.

In yet another embodiment, the second set of wavelengths may consist essentially of wavelengths that are 660 nm.

In a specific embodiment of the above method, the instant or average radiometric intensity of pulses emitted by the first illumination source may be higher than instant or average radiometric intensity of pulses emitted by the second illumination source.

In another embodiment, the instant or average visible intensity of pulses emitted by the first illumination source may be substantially identical to instant or average intensity of pulses emitted by the second illumination source.

In accordance with a particular embodiment, the method may further comprise directing illumination from the first illumination source and from the second illumination source along a common light path onto an image capture region corresponding to the eye based biometric recognition apparatus.

The characteristics of the first strobing pattern and second strobing pattern may be selected such that said first and second strobing patterns are visible as a continuous signal of visible radiation having a substantially constant intensity and color.

In another embodiment of the method, the visual strobing pattern resulting from a combination of the first strobing pattern and the second strobing pattern may effectively be modulated at a frequency ν such that ν≧55 Hz.

An embodiment of the method may be configured wherein for a duration of a sequence of strobed illumination generated by the first illumination source, the second illumination source emits a continuous signal of visible radiation, wherein visible intensity of radiation emitted by the second illumination source is higher than visible intensity of radiation emitted by the first illumination source, and the difference between each of the two visible intensities is sufficient to minimize changes in a subject's visual perception corresponding to strobing of the first illumination source.

The invention additionally provides computer program products configured to implement the apparatuses and methods described above and in further detail throughout the specification.

An embodiment of the invention comprises a computer program product for illuminating an image capture region of an eye based biometric recognition apparatus, comprising a computer usable medium having a computer readable program code embodied therein, the computer readable program code comprising instructions for (i) emitting a first set of radiation wavelengths from a first illumination source in a first strobing pattern, wherein the first set of radiation wavelengths within near infrared (NIR) spectrum, (ii) emitting a second set of radiation wavelengths from a second illumination source, wherein at least part of the second set of radiation wavelengths fall within the visible spectrum and at least part of the second set of radiation wavelengths are distinct from the first set of radiation wavelengths wherein one or more of timing, duration and intensity of illumination emitted by the second illumination source are modulated such that combined radiation emitted by the first illumination source and the second illumination source are perceived by a subject's eye as a continuous signal having a substantially constant intensity and color.

### BRIEF DESCRIPTION OF THE ACCOMPANYING DRAWINGS

FIG. 1 is a functional block diagram of an apparatus for eye based biometric recognition.

FIGS. 2A to 2C respectively illustrate visual responses to controlled periodic variations in radiometric intensity of illumination generated by illumination sources in strobe patterns according to the present invention.

FIGS. 3A to 3D respectively comprise various arrangements illustrating different positions of a first illumination source and a second illumination source according to the present invention.

FIG. 4 illustrates an exemplary smartphone housing the biometric apparatus therewithin.

FIG. 5 illustrates an exemplary computer system in which various embodiments of the invention may be implemented.

### DESCRIPTION OF THE INVENTION

The present invention includes methods, apparatuses and computer programs for providing strobed IR or NIR illumination in an eye based biometric system.

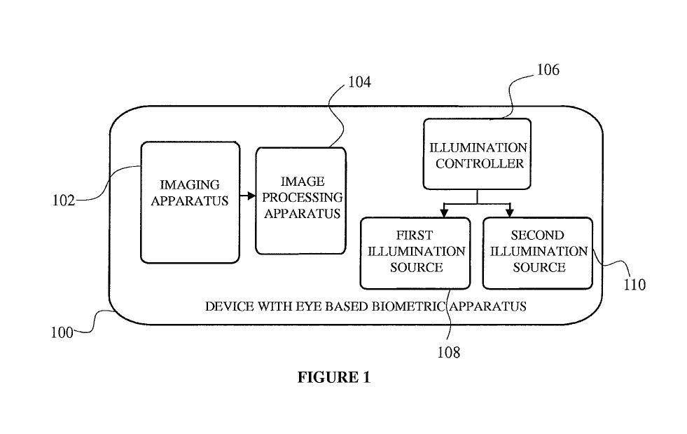

FIG. 1 is a functional block diagram of a device 100 having an apparatus for eye based biometric recognition (e.g. iris or retina based biometric recognition), the device including an imaging apparatus 102 and an image processing apparatus 104. Imaging apparatus 102 acquires an image of the subject's eye and transmits the image to image processing apparatus 104. The image captured by imaging apparatus 102 may be a still image or a video image. Image processing apparatus 104 thereafter analyses and compares data extracted from the captured image of the subject's eye/iris against data extracted from previously acquired eye/iris images, to identify the subject, or to verify the identity of the subject. Device 100 may additionally include a first illumination source 108 and a second illumination source 110, and an illumination controller 106 configured to control illumination provided by the first and second illumination sources 106 and 108 respectively. Illumination controller 106 may be configured to control one or more of timing, intensity and duration of illumination by each of the first and second illumination sources 106 and 108 respectively. Illumination controller 106 may cause either continuous or strobed illumination at one or both of the first and second illumination sources 106 and 108 respectively. In generating strobed illumination, illumination controller 106 may control the pattern, timing, duration and intensity of pulses of illumination generated by each of the first and second illumination sources 106 and 108 respectively.

In an embodiment of the invention first illumination source 108 of device 100 is an illumination source (such as an IR or NIR LED or an LED array) that generates at least a first set of wavelengths falling within the NIR spectrum (i.e. within 700 nm to 1400 nm)—which first set of wavelengths are visible to the unaided human eye. These first set of wavelengths are the only visible wavelengths generated by first illumination source 108 and are visible to the unaided human eye as light having a red color characteristic.

When first illumination source 108 is pulsed or flashed to provide strobed IR or NIR illumination for image capture of a subject's eye, the eye would perceive a series of red flashes corresponding to the strobing pattern of first illumination source 108. The perceived red flashes are a consequence of the first set of NIR wavelengths generated by said first illumination source 108 and which irradiate the subject's eye during image capture.

Second illumination source 110 of device 100 is an illumination source that generates a second set of wavelengths, which second set of wavelengths (i) fall within the visible spectrum and (ii) when incident upon a subject's eye, are sensed and interpreted by the eye as having a color characteristic that is identical (or substantially identical) to the perceived color characteristic corresponding to the first set of wavelengths generated by first illumination source 108 (i.e. a specific red color characteristic). It would be noted that the wavelengths within the second set of wavelengths (which fall within the visible spectrum) are different from the first set of wavelengths (which fall within the NIR spectrum). Nevertheless, when incident upon the unaided human eye, the first set of wavelengths and the second set of wavelengths are perceived as light having identical or substantially identical color characteristics (i.e. a specific red color characteristic).

The second set of radiation wavelengths may be the only visible wavelengths generated by second illumination source 110. As a consequence, illumination generated by second illumination source 110 is visible to the eye as a red light having color characteristics identical to the red light generated by first illumination source 108. Second illumination source 110 may be additionally configured such that it does not generate significant (and in a preferred embodiment, any) radiation falling within the IR or NW spectrum.

In an embodiment, second illumination source 110 may comprise an LED, LED array or any other light source such that all (or substantially all) radiation wavelengths generated by said second illumination source 110 fall within the second set of wavelengths.

It would be understood that in implementation, the first illumination source 108 may additionally generate a third set of wavelengths, which third set of radiation wavelengths are not visible to the unaided human eye. Alternatively, the first illumination source 108 may generate a range of visible wavelengths including the first set of wavelengths, which first illumination source 108 may then be combined with a filter configured to transmit only the NIR wavelengths falling within the first set of wavelengths. Similarly, second illumination source 110 may be configured to generate a range of wavelengths including the second set of wavelengths, which second illumination source 110 may then be combined with a filter configured to only transmit those visible wavelengths which fall within the second set of wavelengths.

In practice, it has been found that where radiometric intensity of the first set of wavelengths generated at the first illumination source 108 is identical to radiometric intensity of the second set of wavelengths generated at the second illumination source 110, the intensity of red color sensed by the human eye in response to incidence of the first set of wavelengths is far less than intensity of red color sensed by the same eye in response to the second set of wavelengths. This difference in a subject's perception of different wavelengths is understood to be a consequence of varying degrees of sensitivity that the human eye exhibits in response to different wavelengths of radiation. It has therefore been found that to ensure that a subject perceives an identical intensity of illumination from both first and second illumination sources, the radiometric intensity of wavelengths generated at the first illumination source 108 requires to be higher that the radiometric intensity of the wavelengths generated at second illumination source 110.

In an embodiment of the invention, the first set of wavelengths generated by the first illumination source may consist essentially of radiation wavelengths between 700 nm to 950 nm. In an embodiment of the invention, the second set of wavelengths generated by the second illumination source may consist essentially of radiation wavelengths between 600 nm and 750 nm and preferably substantially 660 nm.

In operation, illumination controller 106 causes first illumination source 108 to pulse in a first strobe pattern (comprising alternating pulses and intervals between pulses) selected to enable image capture of a subject's eye by the imaging apparatus. Simultaneously, illumination controller 106 causes second illumination source 110 to flash in a second strobe pattern (comprising alternating pulses and intervals between pulses) such that (i) each pulse of the second strobe pattern is synchronized (i.e. corresponds in time and duration) to each interval of the first strobe pattern, and (ii) each interval of the second strobe pattern is synchronized (i.e. corresponds in time and duration) to each pulse of the first strobe pattern.

Of the wavelengths generated by first illumination source 108 that are incident upon the eye, the first set of radiation wavelengths emitted during each pulse would be visible to the subject as a flash having a particular color characteristic. In an embodiment, each pulse of first illumination source 108 would be visible as a flash having a specific red color characteristic. In a preferred embodiment, illumination controller 106 is additionally configured to appropriately control the intensity of flashes generated in the first strobe pattern at the first illumination source 108 and generated in the second strobe pattern at the second illumination source 110 so as to ensure that the visible intensity of both the first and second set of wavelengths as perceived by the subject's eye, are identical (or substantially identical).

In implementing the above first and second strobe patterns at the first and second illumination sources 108 and 110 respectively, illumination controller 106 ensures that for the entire duration of a strobe sequence, a subject's eye would perceive a visual signal of constant intensity and color, which color corresponds to the color perceived by the human eye upon incidence of the first set of NIR wavelengths.

In embodiments of the invention discussed in greater detail below, first and second illumination sources 108 and 110 may be positioned in any arrangement such that their locations are indistinguishable to a subject's eye that is positioned within an image capture region defined for image capture by the biometric device. In an embodiment, of the invention locations of the first and second illumination sources 108 and 110 are indistinguishable to a subject's eye positioned anywhere within a field of view of the imaging apparatus or biometric device.

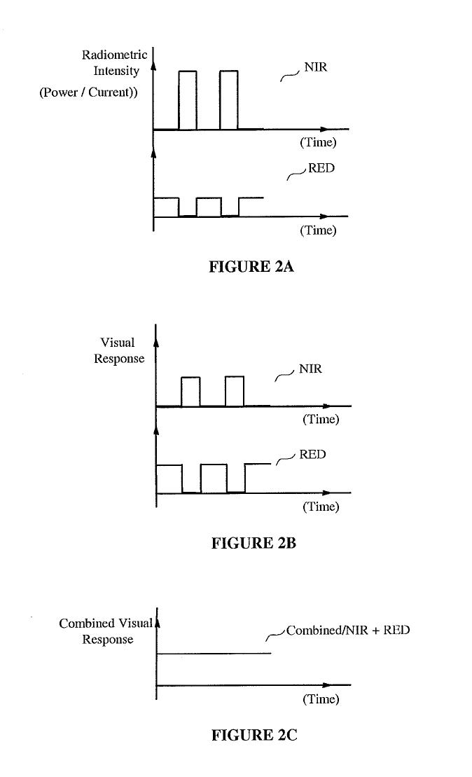

FIGS. 2A to 2C illustrate an embodiment of the invention where the first and second strobe patterns are combined in the manner more generally described above.

FIG. 2A illustrates the first strobe pattern comprising pulses of a first set of wavelengths falling within the NIR spectrum, that are generated by an NIR source (the first illumination source) and are directed upon a subject's eye. Simultaneously, FIG. 2A illustrates the second strobe pattern comprising pulses of a second set of red wavelengths that are generated by a red wavelength source (the second illumination source) and that are directed upon the subject's eye. In the illustrated embodiment the first set of NIR wavelengths and the second set of red wavelengths are selected such that when incident upon the unaided human eye, the first set of NIR wavelengths and the second set of red wavelengths are perceived as light having identical or substantially identical color characteristics (i.e. a specific red color characteristic).

As illustrated in FIG. 2A, pulses in the first strobe pattern generated by the NIR illumination source are synchronized (in timing and duration) to intervals between pulses in the second strobe pattern generated by the red illumination source. Likewise, intervals between pulses in the first strobe pattern generated by the first illumination source are synchronized (in timing and duration) to pulses in the second strobe pattern generated by the red illumination source.

FIG. 2A also charts the first and second strobe patterns in terms of radiometric intensity of illumination generated at the respective illumination sources. It will be noted that the radiometric intensity of wavelengths generated at the NIR illumination source is significantly higher that the radiometric intensity of wavelengths generated at the red illumination source. In a preferred embodiment, the radiometric intensity of wavelengths generated at the NIR illumination source and at the red illumination source are respectively selected such that both illumination sources are perceived at the subject's eye as having identical or substantially identical intensities. The skilled person would appreciate that changes in radiometric intensity generated by an illumination source may be achieved by correspondingly modifying the power/current supplied to the illumination source. It would further be understood that radiometric intensities of the first and second illumination sources may require to be adjusted based on, among other factors, distance between an illumination source and position of a subject's eye, ambient light conditions, and sensitivity of a subject's eye to different wavelengths of radiation.

FIG. 2B illustrates visual response (i.e. the manner in which a subject's eye would perceive wavelengths) corresponding to each of the first strobe pattern and second strobe pattern. It would be observed that as a consequence of the human eye's lower sensitivity to NIR wavelengths in comparison to red visible wavelengths, the intensity of the first strobe pattern and second strobe pattern as perceived by the eye is identical (or substantially identical) despite the difference in radiometric intensity generated at the respective illumination sources. Additionally, when each strobe pattern is implemented in isolation, the subject's eye would perceive the actual pattern of pulses, and intervals between pulses, that are generated at the corresponding illumination source.

FIG. 2C illustrates visual response of a subject when the first strobe pattern generated by the NIR illumination source is synchronized to the second strobe pattern generated by the red illumination source such that (i) each pulse of the second strobe pattern is synchronized (i.e. corresponds in time and duration) to each interval of the first strobe pattern, and (ii) each interval of the second strobe pattern is synchronized (i.e. corresponds in time and duration) to each pulse of the first strobe pattern. Upon synchronization, the subject's eye would perceive the combined first and second strobe patterns as a continuous signal of light having a constant intensity and/or constant color.

As a consequence of the above configurations, in the course of implementing a strobing sequence for illuminating a subject's eye with IR or NIR radiation for image capture, the subject's eye would perceive the combined NIR wavelength radiations generated by first illumination source 108 and the visible red wavelength radiations generated by second illumination source 110, as a continuous signal of red light having a substantially constant intensity.

By pulsing first illumination source 108 (which illuminates the subject's eye with IR or NIR wavelengths), the invention reduces the subject's exposure to IR and NIR spectrum wavelengths. Simultaneously, by combining the first and second strobe patterns such that the subject's eye perceives a continuous emission of red light having a substantially constant intensity (instead of perceiving a strobe pattern of alternate pulses and intervals), the invention eliminates the potentially harmful effects of strobing. Yet further, as illustrated in FIGS. 2A and 2B, in generating pulses of visible red wavelengths that are perceived by a subject's eye as having the same intensity as the red color perceived from an IR or NW illumination source, the required radiometric intensity of illumination generated at the red illumination source is significantly lower than the radiometric intensity of illumination generated at the IR or NIR illumination source. Thus the power expended by the apparatus during the intervals between pulses of the first strobe pattern (i.e. in generating pulses of the second strobe pattern) is far lower than power expended by the apparatus in generating pulses of the first strobe pattern. Accordingly, the invention continues to present a significant power efficiency over embodiments where a continuous signal of IR or NIR radiation is directed upon a subject's eye for image capture.

In addition to the first and second strobe patterns illustrated in FIGS. 2A and 2B, any other combination of strobing/modulation patterns may be selected, such that the combined first and second patterns is either (i) cumulatively constitutes a continuous signal or (ii) is perceived by a subject's eye positioned within an intended image capture region, as a continuous visible signal when the first and second patterns are modulated at a frequency ν (nu), such that ν≧55 Hz.

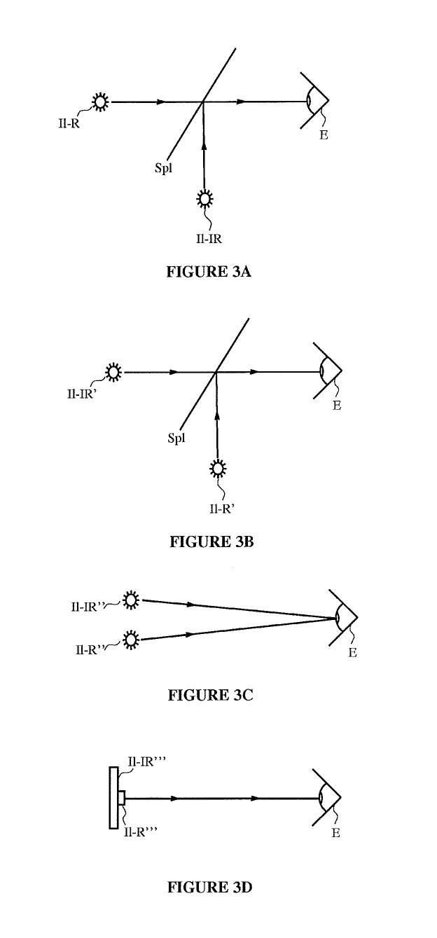

FIGS. 3A to 3D illustrates various arrangements of the invention wherein the positions of the first illumination source (e.g. the NIR illumination source) and the second illumination source (e.g. the red light illumination source) are positioned such that their individual locations are mutually indistinguishable to a subject's eye, when positioned within an image capture region defined for image capture by the biometric device.

FIG. 3A illustrates a first arrangement comprising a first illumination source I1-IR capable of generating a first set of IR or NIR wavelengths and a second illumination source I1-R capable of generating a second set of visible red wavelengths selected such that, when incident upon the unaided human eye, the first set of wavelengths and the second set of wavelengths are each perceived as light having identical or substantially identical color characteristics (i.e. a specific red color characteristic). The arrangement additionally includes a beamsplitter Sp1 positioned such that (i) the first set of wavelengths generated by first illumination source II-IR are reflected off a surface of beam splitter Sp1 and directed along a defined light path onto the subject's eye E, and (ii) the second set of wavelengths generated by second illumination source I1-R are transmitted through beamsplitter Sp1 and directed along the same defined light path onto the subject's eye E.

FIG. 3B illustrates a second arrangement comprising a first illumination source I1-IR′ capable of generating a first set of IR or NIR wavelengths and a second illumination source I1-R′ capable of generating a second set of visible red wavelengths selected such that, when incident upon the unaided human eye, the first set of wavelengths and the second set of wavelengths are each perceived as light having identical or substantially identical color characteristics (i.e. deep red). The arrangement includes beamsplitter Sp1 positioned such that (i) the first set of wavelengths generated by first illumination source I1-IR′ are transmitted through beamsplitter Sp1 and directed along a defined light path onto the subject's eye E and (ii) the second set of wavelengths generated by second illumination source I1-R are reflected off a surface of beam splitter Sp1 and directed along a defined light path onto the subject's eye E.

The skilled person would understand that a beamsplitter is an optical component that partially transmits and partially reflects an incident light beam. In addition to the task of dividing light, beamsplitters can be employed to recombine two separate light beams or images into a single path or to direct light from two separately located sources onto a single path. In each of the arrangements illustrated in FIGS. 3A and 3B, by appropriately positioning beamsplitter Sp1 relative to illumination source I1-IR and I1-R (or I1-IR′ and I1-R′), the invention ensures that illumination from these distinctly located illumination sources may be directed along an identical light path onto the subject's eye—causing the respective locations of both sources of illumination to be mutually indistinguishable to the subject's eye.

FIG. 3C illustrates an alternate configuration of the invention comprising, a first illumination source I1-IR″ (capable of generating a first set of IR or NIR wavelengths) and a second illumination source I1-R″ (capable of generating a second set of visible red wavelengths selected such that, when incident upon the unaided human eye, the first set of wavelengths and the second set of wavelengths are each perceived as light having identical or substantially identical color characteristics) are positioned adjacent to each other, or in the near vicinity of each other, such that when viewed by a subject's eye positioned within an intended image capture region, the relative locations of the two sources of illumination are indistinguishable. In an embodiment this may be achieved by providing the first illumination source and the second illumination source as two adjacent LEDs in an LED array structure or two adjacent LED dies in the same LED package.

FIG. 3D illustrates an alternate configuration of the invention, comprising a first illumination source IL-IR″′ (capable of generating a first set of IR or NIR wavelengths) and a second illumination source IL-R″′ (capable of generating a second set of visible red wavelengths selected such that, when incident upon the unaided human eye, the first set of wavelengths and the second set of wavelengths are each perceived as light having identical or substantially identical color characteristics). One of the first illumination source IL-IR′″ and the second illumination source IL-R″′ may be positioned partially or wholly in front of or on top of the other of the first illumination source IL-IR″′ and the second illumination source IL-R″′, such that when viewed by a subject's eye positioned within an intended image capture region, the relative location of the two sources of illumination are substantially indistinguishable. In an embodiment, the second illumination source IL-R″′ is smaller than the first illumination source IL-IR″′ and is mounted in front of or on top of the larger first illumination source IL-IR″′. In another embodiment, the first illumination source IL-IR″′ and the second illumination source IL-R″′ are positioned relative to each other such that the visible emission generating p-n junction of the second illumination source IL-R″′ is positioned in front of the IR or NW emission generating p-n junction of the first illumination source IL-IR″′. In a specific embodiment, the two illumination sources may be manufactured within a single LED die.

It would be noted that the above description corresponding to each of the invention embodiments illustrated in FIGS. 3A to 3D contemplates a second illumination source (IL-R, IL-R′, IL-R″ or IL-R″′) that is capable of generating a second set of visible red wavelengths selected such that, when incident upon the unaided human eye, the first set of wavelengths and the second set of wavelengths are each perceived as light having identical or substantially identical color characteristics. In certain embodiments of the configurations described in FIGS. 3A to 3D however, the second illumination source (IL-R, IL-R′, IL-R″ or IL-R′″) may be capable of generating a second set of visible wavelengths having color characteristics that are different from the color characteristics of the first illumination source (IL-IR, IL-IR′, IL-IR″ or IL-IR″′). In such embodiments the color characteristics of the second illumination source may be selected based on one or more of luminous efficacy or improved user comfort or desired appearance.

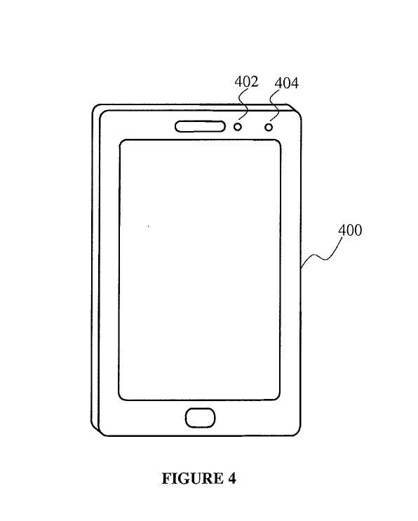

FIG. 4 illustrates an embodiment of the present invention wherein the biometric apparatus is housed within a smartphone 400. Visible on the external casing of smartphone 400 is smartphone camera 402 which may be configured to serve as the imaging apparatus for image capture of a subject's eye. Also visible is a point source of illumination 404 which a subject would perceive as the source of radiation emitted by both a first illumination source and a second illumination source that have been arranged in (i) any of the configurations illustrated in FIGS. 3A to 3C, or (ii) any other appropriate configuration selected such that the individual locations of the first and second sources of illumination are mutually indistinguishable to a subject's eye during image capture.

In an embodiment of the invention, the apparatus for controlling illumination intensity may include a controller for controlling power supplied to the first and second illumination sources and also timing, duration and intensity of illumination generated at the illumination sources in the course of the first and second strobe patterns. In one embodiment, the controller may be a processor implemented control (for example a control implemented by a processor located within a mobile device) capable of controlling illumination generated by the illumination sources. In another embodiment, the controller may comprise a sensor and control circuitry dedicated to control of the illumination sources and that is independent of processors within the mobile device.

In another embodiment, illumination generated at the second illumination source may be continuous (not strobed) and of an intensity such that the corresponding visual response (i.e. the manner in which a subject's eye perceives wavelengths generated by the illumination source) is greater (and preferably significantly greater) than the visual response corresponding to illumination generated at the first illumination source. The effect of this configuration is to ensure that the relative change in a subject's sensory perception corresponding to strobing of the first illumination source is small. Stated differently, by generating illumination of a high intensity at the second illumination source, a subject's perception of changes at the first illumination source (which to the subject's eye, has a much lower or weaker intensity of visible illumination) is significantly lower—thereby making it immaterial whether the first illumination source is blinking or steady. By way of example, by placing a high intensity illumination source (preferably a blinding source of light) adjacent to or substantially in the same position as a much weaker illumination source, a subject viewing both illumination sources is likely to perceive only the high intensity illumination source.

Even if the subject is able to perceive the weaker illumination source, the effect of strobing of this weaker illumination source would be insignificant, owing to the blinding or dazzling effect of the high intensity illumination source. Additionally, in an embodiment of this type, it may not be necessary to ensure that both illumination sources are perceived by the subject as having the same (or substantially the same) color characteristic—for the reason that subject will be either (1) temporarily locally blinded or (2) will avoid looking in the direction of the strong blinding source or (3) not notice the first source because it looks too weak as compared to the second source.

In a more specific embodiment of the above, visible wavelengths generated by the second illumination source may have color characteristics that are different from color characteristics of wavelengths generated from the first illumination source. In a preferred embodiment, the second illumination source emits wavelengths having perceivable white, blue or green color characteristics. Visible spectrum (and corresponding color characteristics) of the second illumination source may be selected to have higher luminous efficacy than a visible light source having the same perceivable color characteristics as the near infrared radiations emitted by the first illumination source (i.e. a visible light source having deep red color characteristics that are substantially identical to the deep red color characteristics of the near infrared emissions from the first illumination source), thereby enabling the second illumination source to consume relatively less power while generating visible wavelengths of a sufficient intensity to overpower the visible characteristics of wavelengths emitted by the first illumination source.

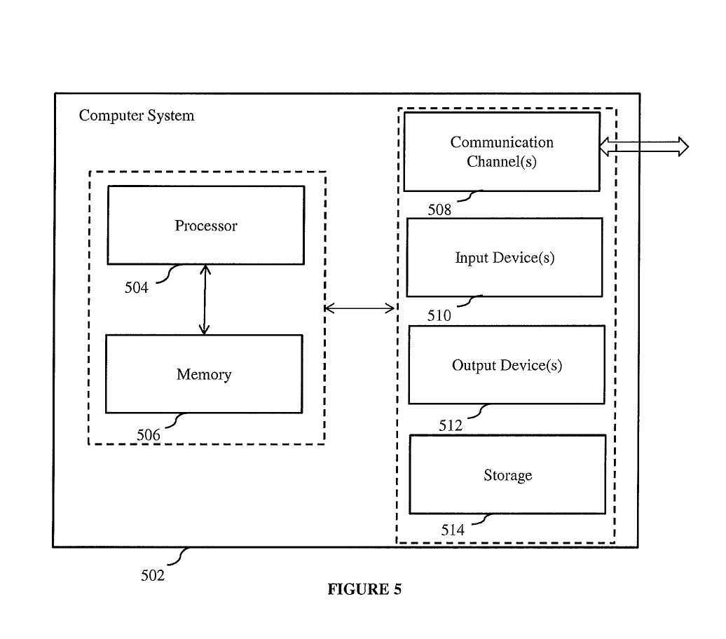

FIG. 5 illustrates an exemplary system in which various embodiments of the invention may be implemented.

The system 502 comprises at-least one processor 504 and at-least one memory 506. The processor 504 executes program instructions and may be a real processor. The processor 504 may also be a virtual processor. The computer system 502 is not intended to suggest any limitation as to scope of use or functionality of described embodiments. For example, the computer system 502 may include, but not limited to, one or more of a general-purpose computer, a programmed microprocessor, a micro-controller, an integrated circuit, and other devices or arrangements of devices that are capable of implementing the steps that constitute the method of the present invention. In an embodiment of the present invention, the memory 506 may store software for implementing various embodiments of the present invention. The computer system 502 may have additional components. For example, the computer system 502 includes one or more communication channels 508, one or more input devices 510, one or more output devices 512, and storage 514. An interconnection mechanism (not shown) such as a bus, controller, or network, interconnects the components of the computer system 502. In various embodiments of the present invention, operating system software (not shown) provides an operating environment for various softwares executing in the computer system 502, and manages different functionalities of the components of the computer system 502.

The communication channel(s) 508 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, bluetooth or other transmission media.

The input device(s) 510 may include, but not limited to, a touch screen, a keyboard, mouse, pen, joystick, trackball, a voice device, a scanning device, or any another device that is capable of providing input to the computer system 502. In an embodiment of the present invention, the input device(s) 510 may be a sound card or similar device that accepts audio input in analog or digital form. The output device(s) 512 may include, but not limited to, a user interface on CRT or LCD, printer, speaker, CD/DVD writer, LED, actuator, or any other device that provides output from the computer system 502.

The storage 514 may include, but not limited to, magnetic disks, magnetic tapes, CD-ROMs, CD-RWs, DVDs, any types of computer memory, magnetic stipes, smart cards, printed barcodes or any other transitory or non-transitory medium which can be used to store information and can be accessed by the computer system 502. In various embodiments of the present invention, the storage 514 contains program instructions for implementing the described embodiments.

In an embodiment of the present invention, the computer system 502 is part of a distributed network where various embodiments of the present invention are implemented for rapidly developing end-to-end software applications.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 502. The method described herein is typically implemented as a computer program product, comprising a set of program instructions which is executed by the computer system 502 or any other similar device. The set of program instructions may be a series of computer readable codes stored on a tangible medium, such as a computer readable storage medium (storage 514), for example, diskette, CD-ROM, ROM, flash drives or hard disk, or transmittable to the computer system 502, via a modem or other interface device, over either a tangible medium, including but not limited to optical or analogue communications channel(s) 508, or implemented in hardware such as in an integrated circuit. The implementation of the invention as a computer program product may be in an intangible form using wireless techniques, including but not limited to microwave, infrared, bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

1. An apparatus for eye based biometric recognition, comprising:
an imaging apparatus;
a first illumination source configured to emit a first set of radiation wavelengths, wherein the first set of radiation wavelengths fall within near infrared (NIR) spectrum;
a second illumination source configured to emit a second set of radiation wavelengths, wherein:
at least part of the second set of radiation wavelengths are distinct from the first set of radiation wavelengths; and
an illumination controller configured to:
strobe the first illumination source in a first strobing pattern; and
control one or more of timing, duration and intensity of illumination emitted by the second illumination source;
wherein combined radiation emitted by the first illumination source and the second illumination source are perceived by a subject's eye as a continuous light having a substantially constant brightness and color; and
wherein the illumination controller is configured to strobe the second illumination source in a second strobing pattern, wherein each pulse of one of the first strobing pattern and the second strobing pattern is substantially synchronized with each interval of the other of the first strobing pattern and the second strobing pattern.

2. The apparatus as claimed in claim 1, wherein visible color characteristics of the second set of wavelengths are substantially identical to visible color characteristics of the first set of wavelengths.

3. (canceled)

4. The apparatus as claimed in claim 2, wherein the first set of wavelengths comprise wavelengths between 700 nm and 1400 nm, and the second set of wavelengths comprise wavelengths between 600 nm and 750 nm.

5. The apparatus as claimed in claim 4, wherein the first set of wavelengths consists essentially of wavelengths between 700 nm to 950 nm.

6. The apparatus as claimed in claim 4, wherein the second set of wavelengths consists essentially of wavelengths that are 660 nm.

7. (canceled)

8. The apparatus as claimed in claim 1, wherein the illumination controller is configured to control radiometric intensity and timing characteristics of pulses emitted by the first illumination source and radiometric intensity and timing characteristics of pulses emitted by the second illumination source such that average visible intensity of pulses emitted by the first illumination source is substantially identical to average visible intensity of pulses emitted by the second illumination source.

9. The apparatus as claimed in claim 1, wherein the first illumination source and the second illumination source are positioned such that their respective locations are substantially indistinguishable from within a field of view of the imaging apparatus.

10. The apparatus as claimed in claim 9, further comprising a beam splitter configured to direct illumination from the first illumination source and from the second illumination source along a common light path onto an image capture region corresponding to the imaging apparatus.

11. The apparatus as claimed in claim 1, wherein characteristics of the first strobing pattern and second strobing pattern are selected such that said first and second strobing patterns are visible as a continuous source of visible radiation having a substantially constant intensity and color.

12. (canceled)

13. (canceled)

14. The apparatus as claimed in claim 1, wherein emission spectrum of the second illumination source is selected such that it has higher luminous efficiency than luminous efficiency of an illumination source configured to emit visible radiation having an emission spectrum color characteristic substantially identical to emission spectrum color characteristic of the first illumination source.

15. (canceled)

16. (canceled)

17. A method for illuminating an image capture region of an eye based biometric recognition apparatus, the method comprising:
emitting a first set of radiation wavelengths from a first illumination source in a first strobing pattern, wherein the first set of radiation wavelengths fall within near infrared (NIR) spectrum;
emitting a second set of radiation wavelengths from a second illumination source, wherein:
at least part of the second set of radiation wavelengths are distinct from the first set of radiation wavelengths;
wherein one or more of timing, duration and intensity of illumination emitted by the second illumination source are modulated such that combined radiation emitted by the first illumination source and the second illumination source are perceived by a subject's eye as a continuous light having a substantially constant brightness and color; and
wherein the second illumination source is strobed in a second strobing pattern, such that each pulse of one of the first strobing pattern and the second strobing pattern is substantially synchronized with each interval of the other of the first strobing pattern and the second strobing pattern.

18. The method as claimed in claim 17, wherein:
visible color characteristics of the second set of wavelengths are substantially identical to visible color characteristics of the first set of wavelengths; and
instant or average visible intensity of pulses emitted by the first illumination source is substantially identical to instant or average intensity of pulses emitted by the second illumination source.

19. (canceled)

20. The method as claimed in claim 18, wherein the first set of wavelengths comprise wavelengths between 700 nm and 1400 nm, and the second set of wavelengths comprise wavelengths between 600 nm and 750 nm.

21. The method as claimed in claim 20, wherein the first set of wavelengths consists essentially of wavelengths between 700 nm to 950 nm.

22. The method as claimed in claim 20, wherein the second set of wavelengths consists essentially of wavelengths that are 660 nm.

23. (canceled)

24. (canceled)

25. The method as claimed in claim 17, further comprising directing illumination from the first illumination source and from the second illumination source along a common light path onto an image capture region corresponding to the eye based biometric recognition apparatus.

26. The method as claimed in claim 17, wherein characteristics of the first strobing pattern and second strobing pattern are selected such that said first and second strobing patterns are visible as a continuous source of visible radiation having a substantially constant intensity and color.

27. (canceled)

28. (canceled)

29. A computer program product for illuminating an image capture region of an eye based biometric recognition apparatus, comprising a computer usable medium having a computer readable program code embodied therein, the computer readable program code comprising instructions for:
emitting a first set of radiation wavelengths from a first illumination source in a first strobing pattern, wherein the first set of radiation wavelengths within near infrared (NIR) spectrum;
emitting a second set of radiation wavelengths from a second illumination source, wherein:
at least part of the second set of radiation wavelengths are distinct from the first set of radiation wavelengths;
wherein one or more of timing, duration and intensity of illumination emitted by the second illumination source are modulated such that:
combined radiation emitted by the first illumination source and the second illumination source are perceived by a subject's eye as a continuous signal having a substantially constant intensity and color; and
the illumination controller is configured to strobe the second illumination source in a second strobing pattern, wherein each pulse of one of the first strobing pattern and the second strobing pattern is substantially synchronized with each interval of the other of the first strobing pattern and the second strobing pattern.
